(19) United States
(12) Patent Application Publication
(10) Pub. No.: US 2026/0124992 A1
(43) Pub. Date: May 7, 2026

(54) FLIP-OUT ELECTRIC RUNNING BOARD AND VEHICLE

(71) Applicant: Zhongshan AOD Electronics Technology Co., Ltd., Zhongshan (CN)

(72) Inventors: Jingyu ZHANG, Zhongshan (CN); Xuanmo GUO, Zhongshan (CN); Tianlong WEI, Zhongshan (CN); Jin WANG, Zhongshan (CN)

(73) Assignee: Zhongshan AOD Electronics Technology Co., Ltd., Zhongshan (CN)

(21) Appl. No.: 19/092,009

(22) Filed: Mar. 27, 2025

Related U.S. Application Data
(63) Continuation of application No. PCT/CN2024/130035, filed on Nov. 5, 2024.

(51) Int. Cl. B60R 3/02

(52) U.S. Cl. CPC B60R 3/02

(57) ABSTRACT

The present invention discloses a flip-out electric running board and a vehicle. The electric running board includes: a running board body; a first mounting seat; a first connecting seat, fixedly connected to one end of the running board body and rotationally connected to the first mounting seat; a connecting rod, where one end is movably connected to the first connecting seat; a swing arm, where one end is movably connected to the other end of the connecting rod; a driving device, disposed on the first mounting seat and connected to the other end of the swing arm, where the driving device can drive the swing arm to swing in a horizontal direction; a second mounting seat; and a second connecting seat, fixedly connected to the other end of the running board body and rotationally connected to the second mounting seat.

### CROSS-REFERENCE TO RELATED APPLICATIONS

The application claims priority to Chinese patent application No. 2023111474388, filed on Sep. 6, 2023, the entire contents of which are incorporated herein by reference.

### TECHNICAL FIELD

The present invention relates to the technical field of vehicles, and in particular, to a flip-out electric running board and a vehicle.

### BACKGROUND

In some vehicle models such as SUV and MPV, since the chassis of these models are higher than those of cars, it is inconvenient for drivers and passengers to get on and off the vehicles. Therefore, these models are generally equipped with running boards to assist the drivers and passengers in getting on and off the vehicles. In addition, the running boards are generally divided into a fixed running board and an electric running board. The fixed running board is fixedly mounted on the vehicle body, and the electric running board drives the running board body through an electric driving structure, so that the running board body can move relative to the vehicle body. Existing electric running boards are connected to the vehicle body through a four-connecting-rod mechanism, and during movement, a motor drives the running board body to swing outward through the four-connecting-rod mechanism. However, due to the extremely limited lateral and longitudinal space of the vehicle body, there is insufficient space to arrange the electric running board. The driving mode of the four-connecting-rod mechanism results in a large movement stroke of the electric running board, especially a lateral stroke, which requires significant space from the vehicle body and is not conducive to the design of a vehicle body structure. Therefore, a novel flip-out electric running board and a vehicle are urgently needed to solve the above problems.

### SUMMARY

The present invention aims to at least solve one of the technical problems existing in the prior art. Therefore, the present invention provides a flip-out electric running board and a vehicle.

To solve the technical problem, an embodiment of the present invention adopts the following technical solutions: A flip-out electric running board includes:
a running board body;
a first mounting seat, capable of being connected to a vehicle body;
a first connecting seat, fixedly connected to one end of the running board body and rotationally connected to the first mounting seat;
a connecting rod, where one end is movably connected to the first connecting seat;
a swing arm, where one end is movably connected to the other end of the connecting rod;
a driving device, disposed on the first mounting seat and connected to the other end of the swing arm, where the driving device can drive the swing arm to swing in a horizontal direction;
a second mounting seat, capable of being connected to the vehicle body; and
a second connecting seat, fixedly connected to the other end of the running board body and rotationally connected to the second mounting seat, where
the driving device can drive the first connecting seat to flip outwards or flip inwards in a vertical direction around an axis of rotation between the first connecting seat and the first mounting seat and can drive the second connecting seat to flip outwards or flip inwards in the vertical direction around an axis of rotation between the second connecting seat and the second mounting seat.

Further, the driving device includes a motor, a worm connected to an output end of the motor, and a worm gear connected to the other end of the swing arm and engaged with the worm, and the motor can drive the worm gear to rotate through the worm, to drive the swing arm to swing in the horizontal direction.

Further, the running board body is provided with a mounting groove and a support groove that are arranged in a stepped manner, and the first connecting seat includes: a second mounting portion that is disposed in the mounting groove and that is connected to the running board body through a detachable structure; and a support portion abutting against the support groove.

Further, the detachable structure is disposed as a first bolt connecting structure.

Further, the first mounting seat includes a first mounting portion and a connecting portion, the first mounting portion can be connected to the vehicle body, the first connecting seat is rotationally connected to the connecting portion, and a clearance groove is formed on the connecting portion, so that the running board body can at least partially extend into the clearance groove when in a retracted state.

Further, the first mounting seat is connected to the vehicle body through a second bolt connecting structure.

Further, a side wall of the vehicle body is provided with an accommodating groove, and the running board body 10 can be at least partially accommodated in the accommodating groove when in a retracted state.

A vehicle includes the electric running board.

Beneficial effects of the present invention are as follows: A flip-out electric running board and a vehicle are provided. The electric running board includes: a running board body; a first mounting seat, capable of being connected to a vehicle body; a first connecting seat, fixedly connected to one end of the running board body and rotationally connected to the first mounting seat; a connecting rod, where one end is movably connected to the first connecting seat; a swing arm, where one end is movably connected to the other end of the connecting rod; a driving device, disposed on the first mounting seat and connected to the other end of the swing arm, where the driving device can drive the swing arm to swing in a horizontal direction; a second mounting seat, capable of being connected to the vehicle body; and a second connecting seat, fixedly connected to the other end of the running board body and rotationally connected to the second mounting seat. The driving device can drive the first connecting seat to flip outwards or flip inwards in a vertical direction around an axis of rotation between the first connecting seat and the first mounting seat and can drive the second connecting seat to flip outwards or flip inwards in the vertical direction around an axis of rotation between the second connecting seat and the second mounting seat. Through the above structure, a lateral stroke obtained when the running board body flips outwards can be shortened, space occupied by the electric running board in the vehicle body can be reduced, and a layout of a structure of the vehicle body can be facilitated.

### BRIEF DESCRIPTION OF THE DRAWINGS

The above and/or additional aspects and advantages of the present invention will become apparent and easy to understand from the description of embodiments in conjunction with the following accompanying drawings.

FIG. 1 is a first schematic structural diagram of a flip-out electric running board in a retracted state;

FIG. 2 is a first schematic structural diagram of a flip-out electric running board in a flipping-out state;

FIG. 3 is a second schematic structural diagram of a flip-out electric running board in a retracted state;

FIG. 4 is a partial enlarged view of a region A in FIG. 3;

FIG. 5 is a partial enlarged view of a region B in FIG. 3;

FIG. 6 is an exploded view of a flip-out electric running board in a flipping-out state; and

FIG. 7 is a partial enlarged view of a region C in FIG. 6.

### DETAILED DESCRIPTION OF THE EMBODIMENTS

This part will describe the specific embodiments of the present invention in detail. The preferred embodiments of the present invention are shown in the accompanying drawings, and the function of the drawings is to supplement the description of the text part of the specification with graphics, which enables people to intuitively and vividly understand each technical feature and the overall technical solutions of the present invention, but cannot be understood as limiting the protection scope of the present invention.

In the description of the present invention, “a plurality of” means more than two, “greater than a number”, “less than a number”, “exceed a number” and the like indicate that the number is excluded, and “above a number”, “below a number”, “within a number”, and the like indicate that the number is included. “First” and “second” are intended only for distinguishing between technical features but cannot be used to indicate or imply relative importance or implicitly specify a quantity of indicated technical features or implicitly specify a sequential relationship of indicated technical features.

In the description of the present invention, it should be understood that the positional descriptions referred to, for example, the directional or positional relationships indicated by up, down, front, rear, left, right, and the like are based on the directional or positional relationships shown in the drawings, and are only for convenience and simplification of description of the present invention, but not for indicating or implying that the referred device or element must have a specific direction and be constructed and operated in a specific direction, and thus should not be construed as limiting the present invention.

In the present invention, unless otherwise expressly defined, the terms such as “dispose”, “mount”, and “connect” should be understood in a broad sense. For example, it can be directly connected or indirectly connected through intermediate media; it can be in fixed connection, detachable connection, or integrated molding; it can be in mechanical connection; and it can be internal connectivity of two components or the interaction relationship between two components. For a person of ordinary skill in the art, specific meanings of the terms in the present invention may be appropriately determined with reference to the specific content in the technical solution.

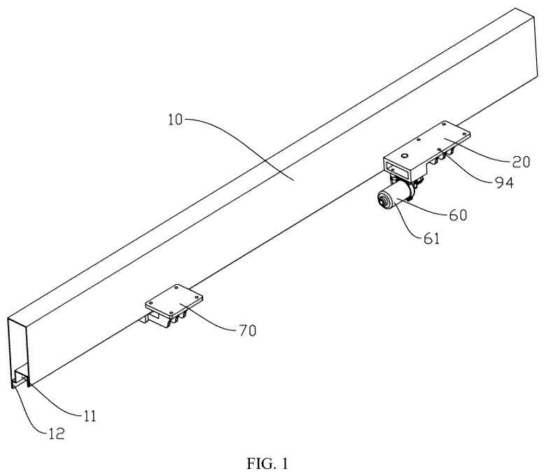

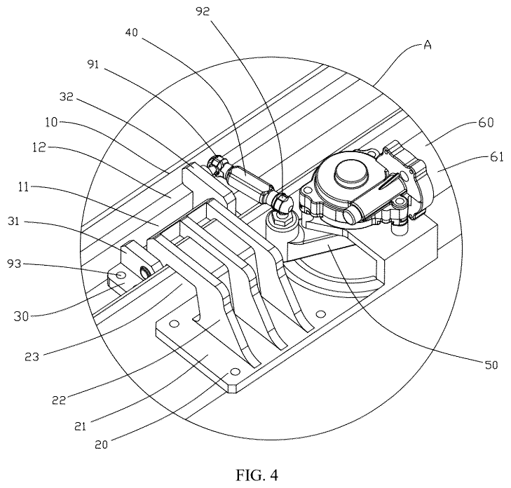

Referring to FIG. 1 to FIG. 7, a flip-out electric running board includes:
a running board body;
a first mounting seat, capable of being connected to a vehicle body;
a first connecting seat, fixedly connected to one end of the running board body and rotationally connected to the first mounting seat;
a flipping driving assembly, connected to the first mounting seat and the first connecting seat respectively;
a second mounting seat, capable of being connected to the vehicle body; and
a second connecting seat, fixedly connected to the other end of the running board body and rotationally connected to the second mounting seat.

The flipping driving assembly can drive the first connecting seat to flip outwards or flip inwards in a vertical direction around an axis of rotation between the first connecting seat and the first mounting seat and can drive the second connecting seat to flip outwards or flip inwards in the vertical direction around an axis of rotation between the second connecting seat and the second mounting seat.

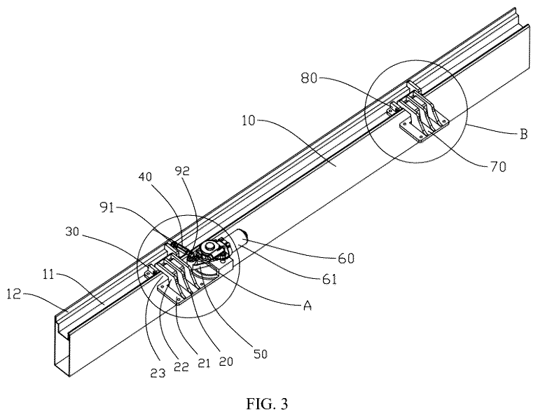

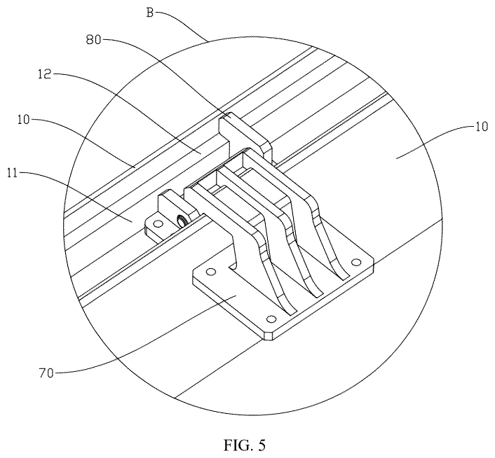

In the present invention, referring to FIG. 1, FIG. 3, and FIG. 5 which are structural diagrams of the electric running board in a retracted state. Specifically, when receiving a control signal sent by a trip computer, a driving device 60 drives a swing arm 50 to swing in a horizontal direction, the first connecting seat 30 is driven to flip outwards in the vertical direction around the axis of rotation between the first connecting seat 30 and the first mounting seat 20 through transmission of a connecting rod 40, and the second connecting seat 80 flips outwards in the vertical direction around the axis of rotation between the second connecting seat 80 and the second mounting seat 70 under transmission of the running board body 10, thereby driving the running board body 10 to flip outwards integrally.

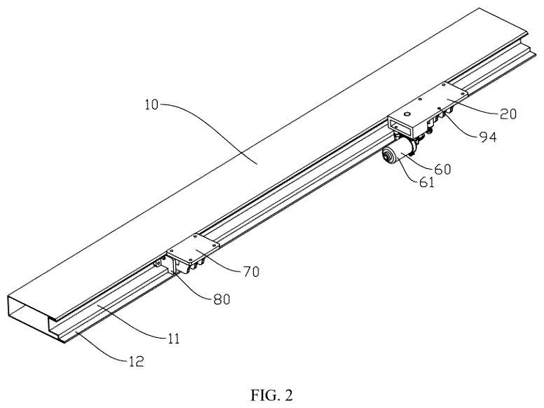

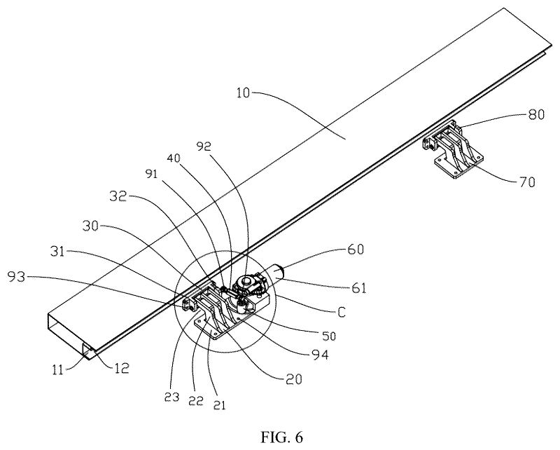

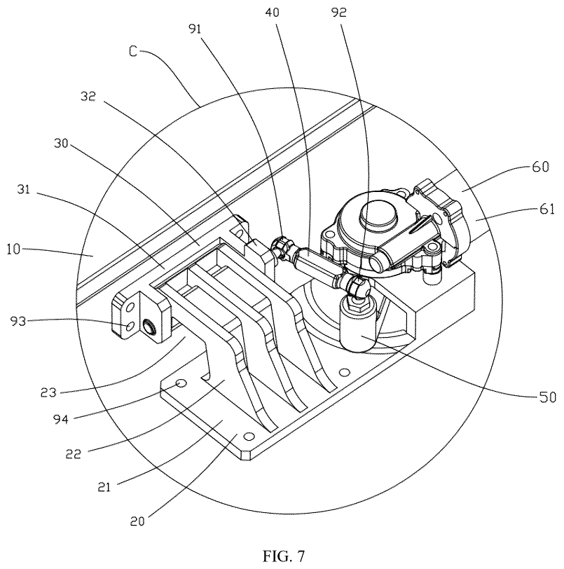

Referring to FIG. 2, FIG. 6, and FIG. 7 which are structural diagrams of the electric running board in a flipping-out state. Specifically, when receiving the control signal sent by the trip computer, the driving device 60 drives the swing arm 50 to swing reversely in the horizontal direction, the first connecting seat 30 is driven to flip inwards in the vertical direction around the axis of rotation between the first connecting seat 30 and the first mounting seat 20 through the transmission of the connecting rod 40, and the second connecting seat 80 flips inwards in the vertical direction around the axis of rotation between the second connecting seat 80 and the second mounting seat 70 under the transmission of the running board body 10, thereby driving the running board body 10 to flip inwards integrally. An advantage of the present invention lies in that: through the above structure, a lateral stroke obtained when the running board body 10 flips outwards can be shortened, space occupied by the electric running board in the vehicle body can be reduced, and a layout of a structure of the vehicle body can be facilitated.

A flipping angle of the running board body 10 can be adjusted according to a radian of a side wall of the vehicle body, which only needs to change a length and a moving angle of the connecting rod 40 and change a length and a moving angle of the swing arm 50. Further, the side wall of the vehicle body is provided with an accommodating groove. The running board body 10 can be at least partially accommodated in the accommodating groove when in the retracted state, thereby further enhancing structural strength of a side edge of a vehicle as a part of a side skirt of the vehicle.

As a preferred embodiment of the flipping driving assembly, the flipping driving assembly includes:
the connecting rod, where one end is movably connected to the first connecting seat through a first ball and socket;
the swing arm, where one end is movably connected to the other end of the connecting rod through a second ball and socket; and
the driving device, disposed on the first mounting seat and connected to the other end of the swing arm, where the driving device can drive the swing arm to swing in the horizontal direction.

The driving device can drive, through the swing arm and the connecting rod, the first connecting seat to flip outwards or flip inwards in the vertical direction around the axis of rotation between the first connecting seat and the first mounting seat and can drive the second connecting seat to flip outwards or flip inwards in the vertical direction around the axis of rotation between the second connecting seat and the second mounting seat.

One end of the connecting rod 40 is movably connected to the first connecting seat 30 through the first ball and socket 91, and the other end of the connecting rod 40 is movably connected to one end of the swing arm 50 through the second ball and socket 92. Through a ball and socket structure, the connecting rod 40 is rotationally connected to the first connecting seat 30 under a large angle, the connecting rod 40 is rotationally connected to the swing arm 50 under a large angle, and the running board body 10 does not get stuck. In addition, the first ball and socket 91 and the second ball and socket 92 may adopt an existing ball and socket structure, which are not described in detail in the present invention and are not construed as a limitation to the present invention.

As a preferred embodiment of the driving device 60, the driving device 60 includes a motor 61, a worm connected to an output end of the motor 61, and a worm gear connected to the other end of the swing arm 50 and engaged with the worm, and the motor 61 can drive the worm gear to rotate through the worm, to drive the swing arm 50 to swing in the horizontal direction.

The running board body 10 is provided with a mounting groove 11 and a support groove 12 that are arranged in a stepped manner. The first connecting seat 30 includes: a second mounting portion 31 that is disposed in the mounting groove 11 and that is connected to the running board body 10 through a detachable structure 93; and a support portion 32 abutting against the support groove 12. The support portion 32 can support the running board body 10 when the electric running board is in the retracted state.

The detachable structure 93 is disposed as a first bolt connecting structure.

The first mounting seat 20 includes a first mounting portion 21 and a connecting portion 22. The first mounting portion 21 can be connected to the vehicle body, the first connecting seat 30 is rotationally connected to the connecting portion 22, and a clearance groove 23 is formed on the connecting portion 22, so that the running board body 10 can at least partially extend into the clearance groove 23 when in the retracted state. By forming the clearance groove 23, the running board body 10 can at least partially extend into the clearance groove 23 when in the retracted state, thereby further reducing the lateral stroke obtained when the running board body 10 flips outwards.

The first mounting seat 20 is connected to the vehicle body through a second bolt connecting structure 94.

A vehicle includes the electric running board.

Certainly, the present invention is not limited to the above implementations. A person skilled in the art may also make equivalent modifications or replacements without departing from the spirit of the present invention. These equivalent modifications and replacements all fall within the scope of the claims of the present application.

What is claimed is:

1. A flip-out electric running board, comprising:
a running board body (10);
a first mounting seat (20), capable of being connected to a vehicle body;
a first connecting seat (30), fixedly connected to one end of the running board body (10) and rotationally connected to the first mounting seat (20);
a connecting rod (40), wherein one end is movably connected to the first connecting seat (30);
a swing arm (50), wherein one end is movably connected to the other end of the connecting rod (40);
a driving device (60), disposed on the first mounting seat (20) and connected to the other end of the swing arm (50), wherein the driving device (60) can drive the swing arm (50)to swing in a horizontal direction;
a second mounting seat (70), capable of being connected to the vehicle body; and
a second connecting seat (80), fixedly connected to the other end of the running board body (10) and rotationally connected to the second mounting seat (70), wherein
the driving device (60) can drive the first connecting seat (30) to flip outwards or flip inwards in a vertical direction around an axis of rotation between the first connecting seat and the first mounting seat (20) and can drive the second connecting seat (80) to flip outwards or flip inwards in the vertical direction around an axis of rotation between the second connecting seat and the second mounting seat (70).

2. The flip-out electric running board according to claim 1, wherein the driving device (60) comprises a motor (61), a worm connected to an output end of the motor (61), and a worm gear connected to the other end of the swing arm (50) and engaged with the worm, and the motor (61) can drive the worm gear to rotate through the worm, to drive the swing arm (50) to swing in the horizontal direction.

3. The flip-out electric running board according to claim 1, wherein the running board body (10) is provided with a mounting groove (11) and a support groove (12) that are arranged in a stepped manner, and the first connecting seat (30) comprises: a second mounting portion (31) that is disposed in the mounting groove (11) and that is connected to the running board body (10) through a detachable structure (93); and a support portion (32) abutting against the support groove (12).

4. The flip-out electric running board according to claim 3, wherein the detachable structure (93) is disposed as a first bolt connecting structure.

5. The flip-out electric running board according to claim 1, wherein the first mounting seat (20) comprises a first mounting portion (21) and a connecting portion (22), the first mounting portion (21) can be connected to the vehicle body, the first connecting seat (30) is rotationally connected to the connecting portion (22), and a clearance groove (23) is formed on the connecting portion (22), so that the running board body (10) can at least partially extend into the clearance groove (23) when in a retracted state.

6. The flip-out electric running board according to claim 1, wherein the first mounting seat (20) is connected to the vehicle body through a second bolt connecting structure (94).

7. The flip-out electric running board according to claim 1, wherein a side wall of the vehicle body is provided with an accommodating groove, and the running board body (10) can be at least partially accommodated in the accommodating groove when in a retracted state.

8. A vehicle, comprising the electric running board according to claim 1.
